(19) United States
(12) Patent Application Publication
(10) Pub. No.: US 2026/0145602 A1
(43) Pub. Date: May 28, 2026

(54) SLIDING SNAP MECHANISM IN SEAT BACK PASS-THROUGH PLASTIC TO AVOID WHIPLASH INJURY

(71) Applicant: FCA US LLC, Auburn Hills, MI (US)

(72) Inventors: Gowtham Prasath Chinnaraj, Chennai (IN); Nataraj Rathakrishnan, Chennai (IN); Alto Joe Prakash Arul Joseph, Chennai (IN); Siddharth Pawar, Auburn Hills, MI (US); Brett Puffpaff, Auburn Hills, MI (US)

(21) Appl. No.: 18/958,840

(22) Filed: Nov. 25, 2024

(51) Int. Cl. B60N 2/68; B60N 2/80; B60N 2/865

(52) U.S. Cl. CPC B60N 2/68; B60N 2/865; B60N 2002/899

(57) ABSTRACT

A vehicle front seat pass-through has a front pass-through positioned adjacent a headrest. A rear pass-through is positioned adjacent the headrest. A mechanism slidably couples the front pass-through with the rear pass-through to enable movement of the front pass-through with respect to the rear pass-through when a seat back cushion is moved into the seat back frame.

### FIELD

The present disclosure relates to automotive vehicles and, more particularly, to vehicle seats with a seat back pass-through plastic.

### BACKGROUND

This section provides background information related to the present disclosure which is not necessarily prior art.

Vehicle seats are designed to provide performance for the occupant. The vehicle seats are designed for occupant comfort as well as occupant safety. Thus, the seats are designed to withstand outside influence impacts. One area of the vehicle seat that is important for balancing impact is the seat back pass-through plastic.

Generally, this part helps to maintain the rigidity of the seat back. The pass-through is generally provided in integrated seats that a seat back with an integrated headrest. The pass-through is present to assist in occupant movement into the seat back. Generally, the pass-through is rigid and provides for very little movement of the occupant into the seat back. Various types of solutions have been proposed to enable movement into the seat back by the passenger.

One solution is a core-out provided in the seat back foam to improve occupant movement into the seat back. Also, scrim cut outs are provided to increase the flexibility of the seat back form. However, these solutions can only be applied to standard seats with complete foam in the seat back. It is unable to utilize these features for integrated design with plastics in the seat back. Also, due to the cut outs, this affects the occupant comfort during regular usage.

Accordingly, it is desirable to have a seat with a seat back that provides optimal comfort and performance during use by the occupant. Thus, designers strive to improve the art to provide such features in the vehicle seating area.

The present disclosure provides a seat back pass-through plastic that enables substantially unrestricted occupant movement into the seat back. The present disclosure enables the occupant to have uninterrupted movement into the seat back. The present disclosure provides a low cost solution without affecting the aesthetic or styling of the seat back.

### SUMMARY

This section provides a general summary of the disclosure, and is not a comprehensive disclosure of its full scope or all of its features.

According to a first aspect of the disclosure, a vehicle front seat pass-through plastic comprises a front pass-through positioned adjacent a headrest. A rear pass-through is positioned adjacent the headrest. A mechanism slidably couples the front pass-through with the rear pass-through to enable movement of the front pass-through with respect to the rear pass-through when a seat back cushion is moved into the seat back frame. The coupling mechanism includes a plurality of sliding snaps. The sliding snaps each include a loop coupled with a stop. The front and rear pass-throughs include apertures to receive headrests supports. The front and rear pass-throughs include reinforcement members. The front pass-through slides on the rear pass-through.

A vehicle seat comprises a seat base and a frame. A seat back is coupled with the seat base and the frame. The seat back includes a pass-through plastic. The pass-through plastic comprises a front pass-through positioned adjacent a headrest. A rear pass-through is positioned adjacent the headrest. A mechanism slidably couples the front pass-through with the rear pass-through to enable movement of the front pass-through with respect to the rear pass-through when a seat back cushion is moved into the seat back frame. The coupling mechanism includes a plurality of sliding snaps. The sliding snaps each include a loop coupled with a stop. The front and rear pass-throughs include apertures to receive headrests supports. The front and rear pass-throughs include reinforcement members. The front pass-through slides on the rear pass-through.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic perspective view of a vehicle seat with a pass through.

FIG. 2A is a perspective view of the separates of a pass through.

FIG. 2B is a plan view of FIG. 2A.

FIG. 3 is a perspective view of the pass through.

FIG. 4 is a perspective view of a sliding snap.

FIG. 5 is a perspective view of a second embodiment of the pass through.

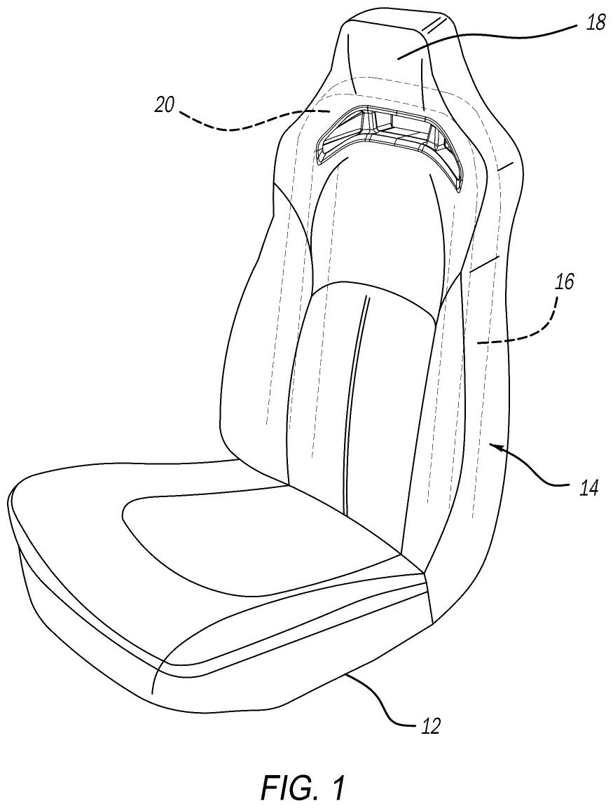

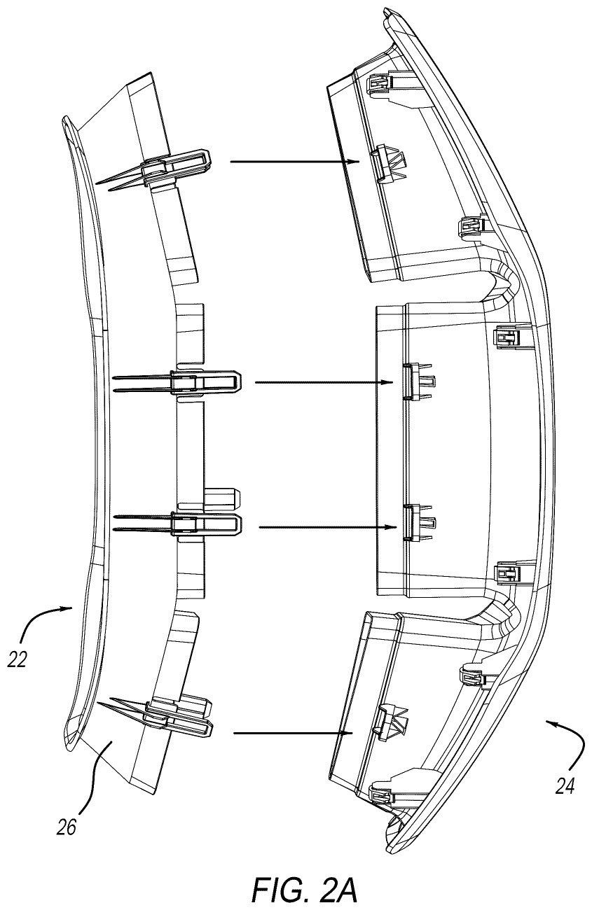

Corresponding reference numerals indicate corresponding parts throughout the several views of the drawings.

### DETAILED DESCRIPTION

Example embodiments will now be described more fully with reference to the accompanying drawings.

Turning to the figures, a vehicle seat is illustrated and designated with the reference numeral 10. The vehicle seat includes a base 12, a seat back 14 integrated with a frame 16. A seat pass-through plastic 20 is illustrated in the seat back 14 adjacent the headrest 18. The pass-through 20 is positioned below the headrest and above the seat back 14 in the integrated seat 10.

The pass-through 20 includes a front part 22 and a rear part 24. The front part 22 and rear part 24 slide with respect to one another to enable the front part 22 to ride on the rear part 24 to absorb impact from the occupant to enable the occupant to move into the seat back 14. The front part 22 and rear part 24 have an overall box shape with a front part peripheral wall 26 sliding on a rear part peripheral wall 28.

Also, the front and rear parts 22, 24 include rails 30, 32 that act together to enable the sliding movement of the front and rear parts 22, 24 with respect to one another.

The front and rear parts 22, 24 include a sliding snap mechanism 40. The sliding snap mechanism 40 includes a loop 42 and a stop 44. The loop 42 includes a pair of legs 44, 46 extending through apertures 50 in a bar 48 which controls the sliding movement of the legs 44, 46 through the apertures 50 in the bar 48. Thus, the legs 44, 46 move smoothly through the bar 48 as the web 52 abuts the stop 44. This enables the continuous movement of the seat back cushion into the frame 16 to enable movement of the seat back 14 during an impact. Thus, the front plastic part 22 moves and slides on the rear plastic part 24 in the axial direction.

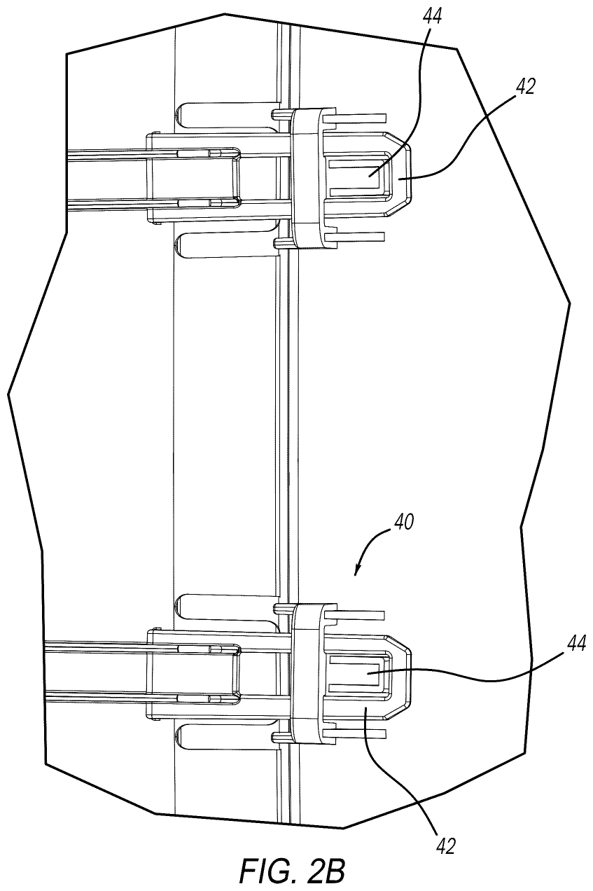

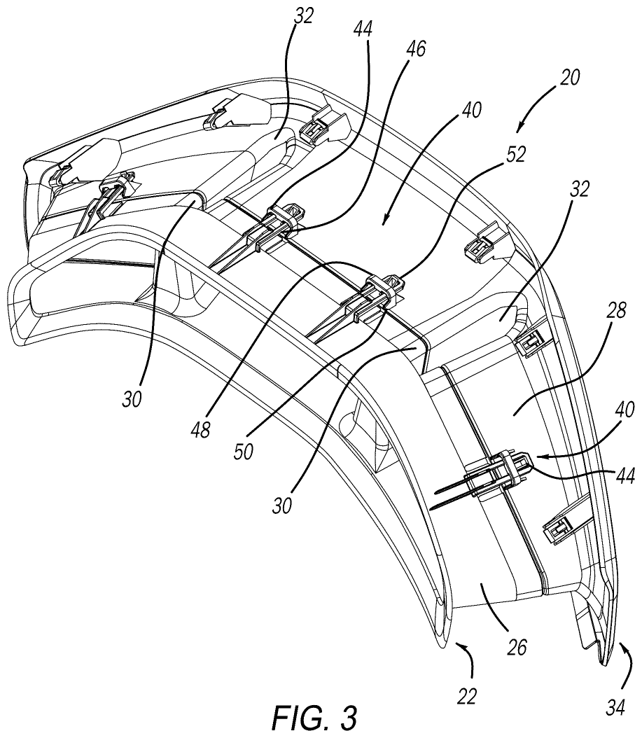

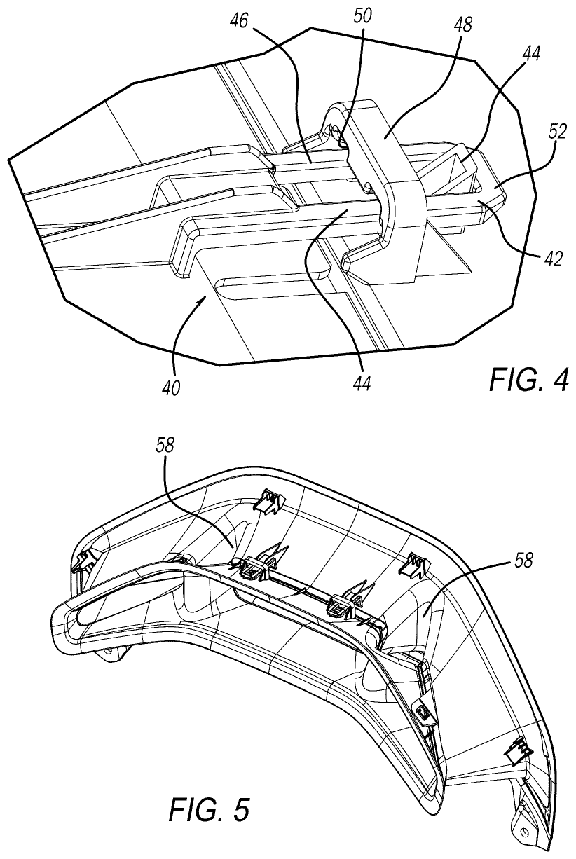

FIG. 5 is an illustration like FIG. 3 having the sliding snap mechanism 40 in reverse. Here, the loop 42 is secured with the rear part 24 and the stop 44 is on the front part 22. Also, apertures 58 are illustrated to enable passage of the headrest supports.

Thus, the present disclosure enables a pass-through without the addition of extra parts and enables modification of existing parts. No additional weight is added and thus a minimum increase is occurred. The present disclosure is more robust under all operating conditions with minimal cost addition and without any effect on the occupant comfort. Further, the seat meets its aesthetic appeal without styling changes. Thus, the seat pass-through plastic enables axial movement without material removal as in previous solutions. The object is achieved without comprising occupant comfort.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle front seat pass-through plastic comprising:
a front pass-through positioned adjacent a headrest;
a rear pass-through positioned adjacent the headrest;
a mechanism slidably coupling the front pass-through with the rear pass-through for enabling movement of the front pass-through with respect to the rear pass-through when a seat back cushion is moved into a seat back frame.

2. The vehicle front seat pass-through plastic of claim 1, wherein the coupling mechanism includes a plurality of sliding snaps.

3. The vehicle front seat pass-through plastic of claim 1, wherein each sliding snap includes a loop coupled with a stop.

4. The vehicle front seat pass-through plastic of claim 1, wherein the front and rear pass-throughs include apertures to receive headrests supports.

5. The vehicle front seat pass-through plastic of claim 1, wherein the front and rear pass-throughs include reinforcement members.

6. The vehicle front seat pass-through plastic of claim 1, wherein the front pass-through slides on the rear pass-through.

7. A vehicle seat comprising:
a seat with a frame;
a seat back; and
a front pass-through positioned adjacent a headrest;
a rear pass-through positioned adjacent the headrest;
a mechanism slidably coupling the front pass-through with the rear pass-through for enabling movement of the front pass-through with respect to the rear pass-through when a seat back cushion is moved into the seat back frame.

8. The vehicle seat of claim 7, wherein the coupling mechanism includes a plurality of sliding snaps.

8. The vehicle seat of claim 7, wherein each sliding snap includes a loop coupled with a stop.

10. The vehicle seat of claim 7, wherein the front and rear pass-throughs include apertures to receive headrests supports.

11. The vehicle seat of claim 7, wherein the front and rear pass-throughs include reinforcement members.

12. The vehicle seat of claim 7, wherein the front pass-through slides on the rear pass-through.
